(19) United States
(12) Patent Application Publication
(10) Pub. No.: US 2026/0218719 A1
(43) Pub. Date: Jul. 30, 2026

(54) PUMP SYSTEM

(71) Applicant: Pentair Flow Technologies, LLC, Delavan, WI (US)

(72) Inventors: Jason Jirjis, Plymouth, MN (US); Amol Shidhore, Greater Noida West (IN); Rohit Seth, New Delhi (IN); Mukesh Kumar, Ghaziabad (IN); Saikat Das, Ghaziabad (IN); Kirankumar Appa Chaugule, Ghaziabad (IN); Jeff Hermes, Shoreview, MN (US); Craig Amundson, Maple Grove, MN (US)

(21) Appl. No.: 19/459,922

(22) Filed: Jan. 26, 2026

Related U.S. Application Data
(60) Provisional application No. 63/749,310, filed on Jan. 24, 2025.

(51) Int. Cl. F04D 29/10; F04D 1/00; F04D 13/04; F04D 13/06

(52) U.S. Cl. CPC F04D 29/106; F04D 1/00; F04D 13/04; F04D 13/06

(57) ABSTRACT

A pump includes a volute, an impeller, a drive-side housing, a chamber plate, a drive shaft, and a positive drive seal. The volute has an inlet port. The impeller is at least partially disposed within the volute. The impeller has a suction collar extending axially into the inlet port. The drive-side housing is mounted to the volute. The chamber plate is positioned between the volute and the drive-side housing. The chamber plate and the drive-side housing define a wet seal chamber. The drive shaft is secured to the impeller and extends through the wet seal chamber. The positive drive seal is disposed in the wet seal chamber. The positive drive seal is non-rotatably secured about the drive shaft and is rotatably engaged with the chamber plate. The positive drive seal forms a seal with the chamber plate.

### CROSS-REFERENCES TO RELATED APPLICATIONS

This application claims priority to U.S. Provisional Patent Application No. 63/749,310, filed Jan. 24, 2025, the entire contents of which are incorporated herein by reference.

### BACKGROUND

Centrifugal pumps are often used to move fluid (e.g., water, oil, etc.) from one location to another. These pumps include an impeller rotatably disposed within a housing to move fluid from an axial inlet to a tangential outlet. The impeller is often driven by a shaft of a drive source, such as a motor sealably extending into the pump. Consequently, in conventional pumps, the motor is operatively fixed to the pump and cannot be exchanged without disassembling the entire pump.

### SUMMARY

In one independent aspect, a pump includes a volute, an impeller, a drive-side housing, a chamber plate, a drive shaft, and a positive drive seal. The volute has an inlet port. The impeller is at least partially disposed within the volute. The impeller has a suction collar extending axially into the inlet port. The drive-side housing is mounted to the volute. The chamber plate is positioned between the volute and the drive-side housing. The chamber plate and the drive-side housing define a wet seal chamber. The drive shaft is secured to the impeller and extends through the wet seal chamber. The positive drive seal is disposed in the wet seal chamber. The positive drive seal is non-rotatably secured about the drive shaft and rotatably engaged with the chamber plate. The positive drive seal forms a seal with the chamber plate.

In some aspects, the positive drive seal is rotatably engaged and forms a seal with the drive-side housing. In some aspects, the impeller is axially centered between a front wall and a rear wall of the volute. In some aspects, the volute defines a circumferential outflow passage, the circumferential outflow passage is substantially V-shaped in cross-section along a first portion of the volute, and the circumferential outflow passage is C-shaped in cross-section along a second portion of the volute. In some aspects, radial outflow channels defined in the impeller are axially aligned with the circumferential outflow passage. In some aspects, an apex along the first portion of the volute is radially opposite an arc along the second portion of the volute. In some aspects, a first inner diameter of the inlet port is approximately equal to a second inner diameter of the suction collar. In some aspects, a diaphragm disposed in the wet seal chamber regulates fluid pressure within the volute. In some aspects, an inner diameter of the inlet port is between about 30 percent and about 40 percent of an outer diameter of the volute in length.

In another independent aspect, a pump includes a volute and an impeller. The volute has an internal shoulder defined by an inlet port and a neck portion. The impeller is rotatable relative to the volute. The impeller has a suction collar disposed in the neck portion, the suction collar and the inlet port being substantially equal in inner diameter. The impeller has a vane having a leading edge extending axially into the suction collar.

In some aspects, the vane has a leading end and a trailing end, and the leading end has a first thickness dimension that is smaller than a second thickness dimension of the trailing end. In some aspects, the leading edge connects to the suction collar. In some aspects, the vane is one of a plurality of vanes, and the plurality of vanes includes no more than six vanes. In some aspects, a distance defined between adjacent apexes of the vanes ranges from about three eighths to about five eighths of an inner diameter of the suction collar. In some aspects, the impeller has a balancing ring larger in inner diameter than the suction collar. In some aspects, an inner diameter of the suction collar is between about 45 percent and about 55 percent of an outer diameter of the impeller in length. In some aspects, an inner curvature diameter of the vane is between about 65 percent and about 75 percent of an outer diameter of the impeller in length.

In another independent aspect, a pump system includes a pump and a motor. The pump has a motor mounting adapter, a drive shaft extending into the motor mounting adapter, and a positive drive seal non-rotatably secured about the drive shaft to fluidly isolate a wet seal chamber from a volute. The motor is removably supported by the motor mounting adapter. The motor has a motor shaft removably coupled to the drive shaft. The pump and the motor have a combined weight of less than 50 pounds.

In some aspects, an end of the motor shaft is inserted into a motor shaft cavity defined in the drive shaft. In some aspects, the motor is one of electrically powered or hydraulically powered.

In overview of the present teaching, this disclosure provides an improved centrifugal pump system that includes a high efficiency impeller and volute assembly, a positive drive seal, and a modular motor mounting block adaptable to multiple power source types.

More specifically, the impeller is aligned axially symmetrically within the volute, and outlet flow passages of the impeller are radially aligned with an outlet channel of the volute. Further, an inlet diameter of the volute is at least one third of an outer diameter of the volute in length. A chamber plate is positioned between the volute and a drive-side housing. A diaphragm behind the chamber plate helps to regulate pressure in the pump. In some forms, the chamber plate and diaphragm form part of a wet seal chamber, such as the wet seal chamber embodiments described in U.S. Pat. No. 9,347,458, which is incorporated herein by reference.

Further, an inlet diameter of the impeller is at least one half of an outer diameter of the impeller in length. Additionally, in some instances, the impeller includes six or fewer vanes arranged radially symmetrically relative to one another about a rotational axis. In some instances, each of the vanes extends axially into an inlet collar of the impeller. In some instances, an inner curvature diameter of a trailing region of each vane is approximately seven tenths of the outer diameter of the impeller in length. Moreover, each of the vanes increases in thickness as the vanes extend radially outwardly. In some instances, the impeller is formed of stainless steel. The impeller may also have an axially extending balancing ring to balance the impeller. Further, the impeller may also define a plurality of axial ports to balance the pressure in front of and behind the impeller, which relieves pressure on the positive drive seal when combined with the diaphragm described above.

Additionally, the positive drive seal is fixedly mounted to a drive shaft via a set screw and, in some instances, is immersed in lubricant that is contained in the wet seal chamber. The positive drive seal includes end faces formed of a hard-wearing material (e.g., ceramic carbide). In some forms, springs can be positioned between the positive drive seal and the drive shaft to help radially center the positive drive seal relative to the drive shaft. Further, O-ring seals are circumferentially disposed within grooves formed on an inner surface of a cylindrical body of the positive drive seal. In some instances, the drive shaft has an outer diameter that is at least one tenth of the outer diameter of the impeller in length. In some forms, the drive shaft defines torque-transmitting (e.g., keyed, splined, etc.) motor shaft input cavity to accommodate multiple types of motors (e.g., hydraulic, electric, etc.). In some forms, the drive shaft defines a torque-transmitting motor shaft protrusion coupling that can accommodate multiple types of motors. The drive shaft is rotatably supported by sealed bearing.

Overall, these various features of the volute, impeller, and positive drive seal work together to improve fluid-moving performance, efficiency, and longevity of the pump. Thus, resulting operational and maintenance costs may be reduced.

### BRIEF DESCRIPTION OF THE DRAWINGS

The accompanying drawings, which are incorporated in and form a part of this specification, illustrate embodiments of the disclosure and, together with the description, serve to explain the principles of embodiments of the disclosure:

FIG. 1 is a front isometric view of a pump system, according to an embodiment;

FIG. 2 is a rear isometric view of a pump of the pump system of FIG. 1;

FIG. 3 is a top plan view of the pump of FIG. 2;

FIG. 4 is an exploded view of the pump of FIG. 2;

FIG. 5 is a cross-sectional view of the pump of FIG. 2 taken along line A-A of FIG. 3;

FIG. 6 is a rear isometric view of a volute of the pump of FIG. 2;

FIG. 7 is a rear elevational view of the volute of FIG. 6;

FIG. 8 is a cross-sectional view of the volute of FIG. 6 taken along line B-B of FIG. 7;

FIG. 9 is a front isometric view of an impeller of the pump of FIG. 2;

FIG. 10 is a front elevational view of the impeller of FIG. 9;

FIG. 11 is a side elevational view of the impeller of FIG. 9;

FIG. 12 is a cross-sectional view of the impeller of FIG. 9 taken along line C-C of FIG. 10;

FIG. 13 is a cross-sectional view of the impeller of FIG. 9 taken along line D-D of FIG. 11;

FIG. 14 is a front isometric view of a drive seal of the pump of FIG. 2;

FIG. 15 is a side elevational view of the drive seal of FIG. 14;

FIG. 16 is a cross-sectional view of the drive seal of FIG. 14 taken along line E-E of FIG. 15; and

FIG. 17 is a performance graph of the pump of FIG. 2.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings, but can also refer to communicative, electrical, or fluidic couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

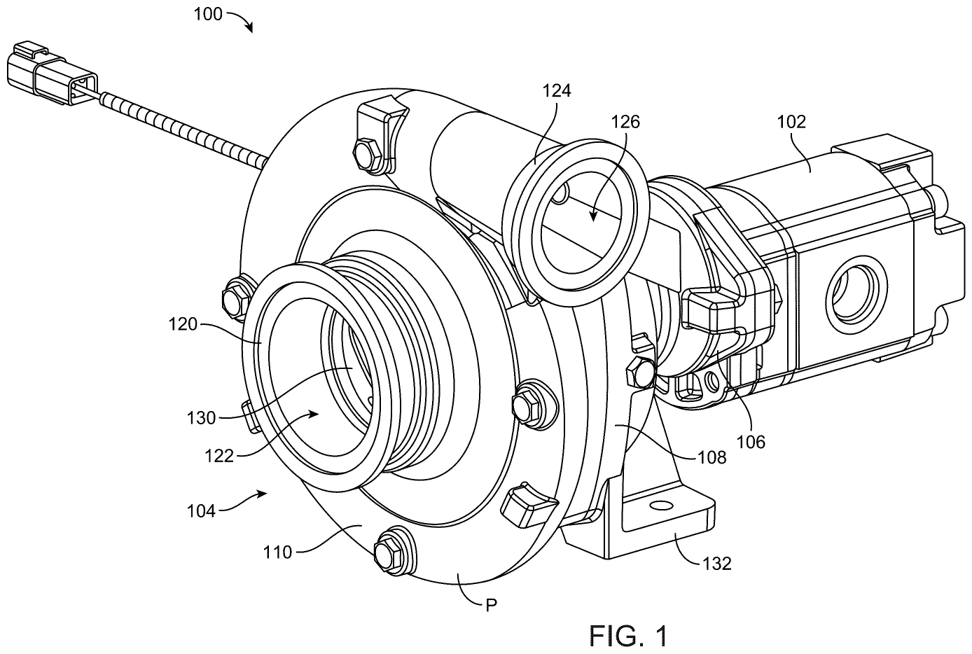

Referring generally to FIG. 1, a pump system 100 according to the disclosure is illustrated. The pump system 100 includes a motor 102 removably and operatively connected to a pump 104 via a motor mounting adapter 106. The pump 104 includes a drive-side housing 108, which is connected to the motor mounting adapter 106, and a volute 110. The volute 110 includes a flanged inlet port 120 that extends axially outward and defines an inlet 122. An inner surface of the inlet port 120 can include female NPT threads for coupling with a pipe having male NPT threads. The volute 110 also includes a discharge port 124 that defines an outlet 126. An inner surface of the discharge port 124 can include female NPT threads for coupling with a pipe having male NPT threads. In some forms, the discharge port 124 extends tangentially from a circumferential perimeter P of the volute 110. The pump 104 further includes an impeller 130 rotatably disposed within the volute 110. The motor 102 drivably rotates the impeller 130. Additionally, the drive-side housing 108 includes at least one pedestal mount 132.

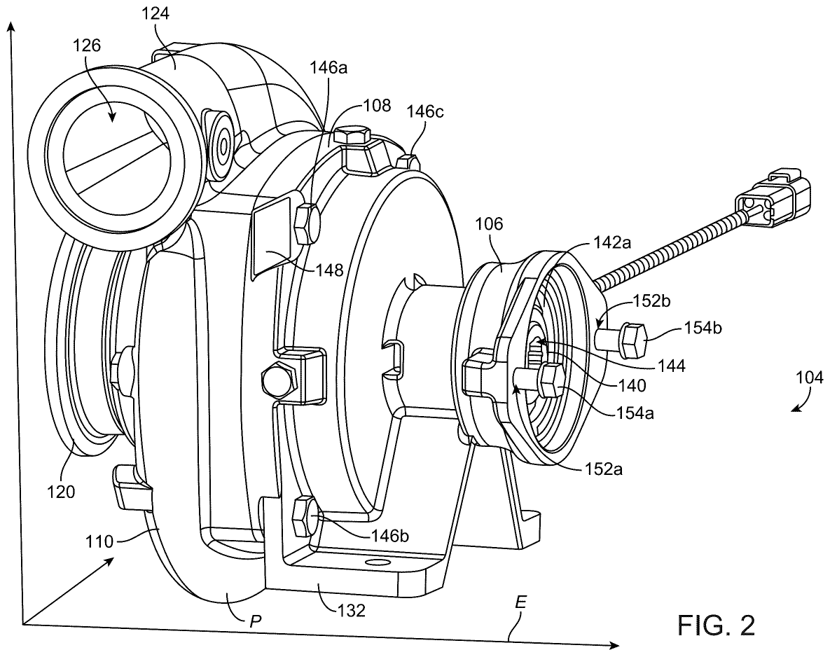

With reference to FIG. 2, the pump 104 further includes a drive shaft 140 rotatably supported in and by the motor mounting adapter 106 via a first sealed bearing 142a. The drive shaft 140 defines a motor shaft cavity 144 internally shaped (e.g., keyed, keyway, splined, toothed, etc.) to receive and transmit torque from a shaft (not shown) of the motor 102 (shown in FIG. 1). The shaft of the motor 102 can be configured to physically correspond with motor shaft cavity 144. For example, the shaft of the motor 102 can include a male end with an external shape (e.g., keyed, keyway, splined, toothed, etc.) that corresponds to the internal shape of the motor shaft cavity 144. Alternatively, in some forms, the drive shaft 140 includes a male end instead of the motor shaft cavity 144, and the shaft of the motor 102 includes a corresponding cavity such that the shaft of the motor 102 forms a female end that corresponds to the male end of the drive shaft 140. In this way, the pump 104 is modularly adaptable to receive numerous types of motors 102 (e.g., electric, hydraulic, etc.). As shown, the motor 102 is hydraulic.

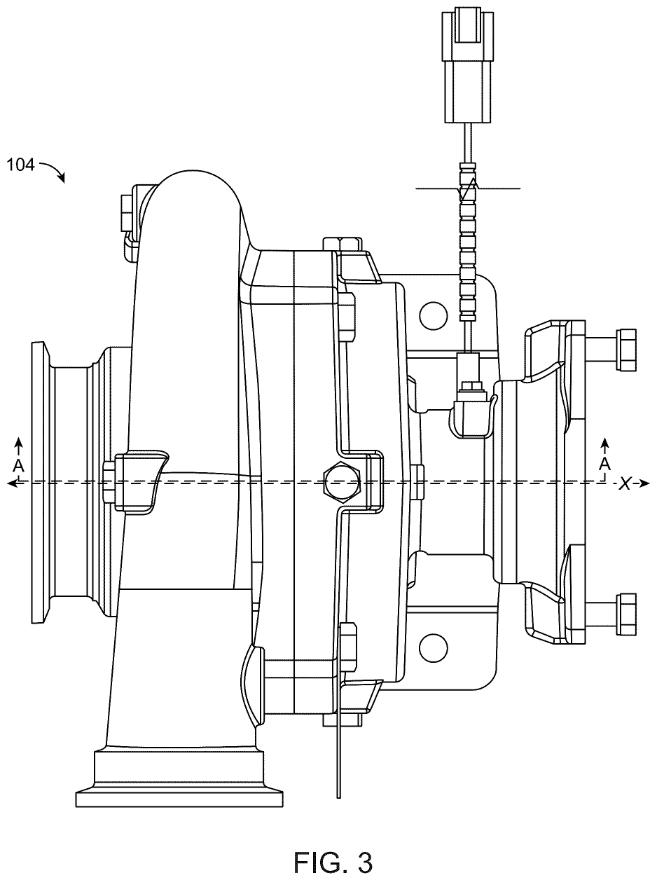

Referring further to FIG. 2, the volute 110 is mounted to the drive-side housing 108 via a first plurality of fasteners 146a-146c. In some instances, an information tag 148 is mounted to the drive-side housing 108 via one of the fasteners 146c. In some instances, the motor mounting adapter 106 is integrally connected to the drive-side housing 108. In some instances, the motor mounting adapter 106 is selectively mountable to the drive-side housing 108. The motor mounting adapter 106 can also define a plurality of mounting openings 152a, 152b configured to receive a second plurality of fasteners 154a, 154b. Thus, the motor mounting adaptor 106 adaptively connects to and supports multiple types of motors 102 (e.g., electric, hydraulic, etc.). More specifically, in some instances, the pump 104 has an overall build envelope E that fits within a space of about 20.015 centimeters long by about 26.04 centimeters wide by about 25.4 centimeters high. The drive shaft 140 defines a rotational axis X, as shown in FIG. 3.

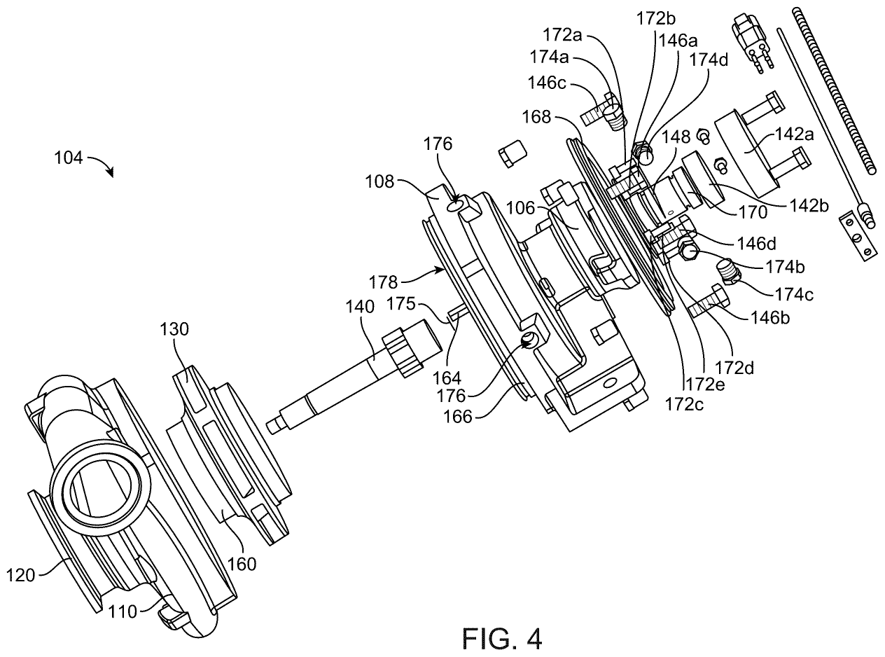

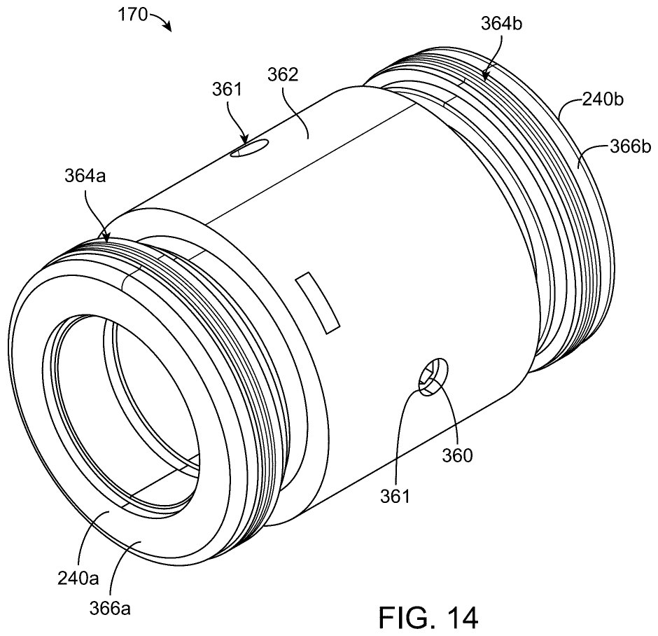

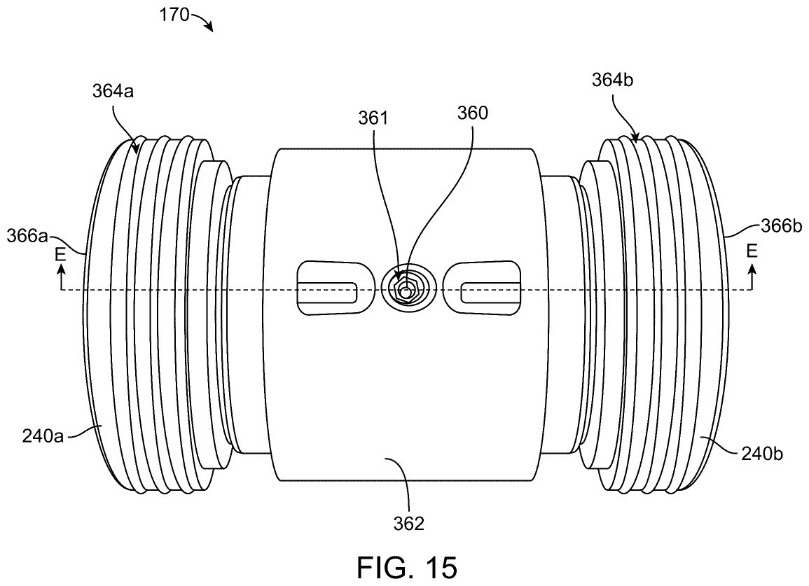

With reference to FIG. 4, the pump 104 further includes a key 164, a chamber plate 166, a diaphragm 168, a positive drive seal 170, a third plurality of fasteners 172a-172e, and a plurality of fill plugs 174a-d. The volute 110 rotatably supports the impeller 130 adjacent to the flanged inlet port 120. The impeller 130 is axially secured onto the drive shaft 140 via a retainer 175 (e.g., a snap ring). In some forms, the impeller 130 is secured to the drive shaft via fastener, such as an acorn nut, in addition to or in place of the retainer 175. The key 164 transmits torque from the drive shaft 140 to the impeller 130. The chamber plate 166 is secured to the drive-side housing 108 via the third plurality of fasteners 172a-172e. The positive drive seal 170 fixedly mounts to the drive shaft 140 as will be described in further detail below with respect to FIGS. 14-16. The fill plugs 174a-174d removably plug openings 176 defined in the drive-side housing 108. The plurality of fill plugs 174a-174d are positioned in different orientations in the drive-side housing 108 such that lubricant can be added, replaced, or drained from multiple locations depending on the orientation in which the pump 104 is mounted to equipment. In some forms, the diaphragm 168 is in fluid communication with the volute 110 via a plurality of openings 178 defined in the chamber plate 166.

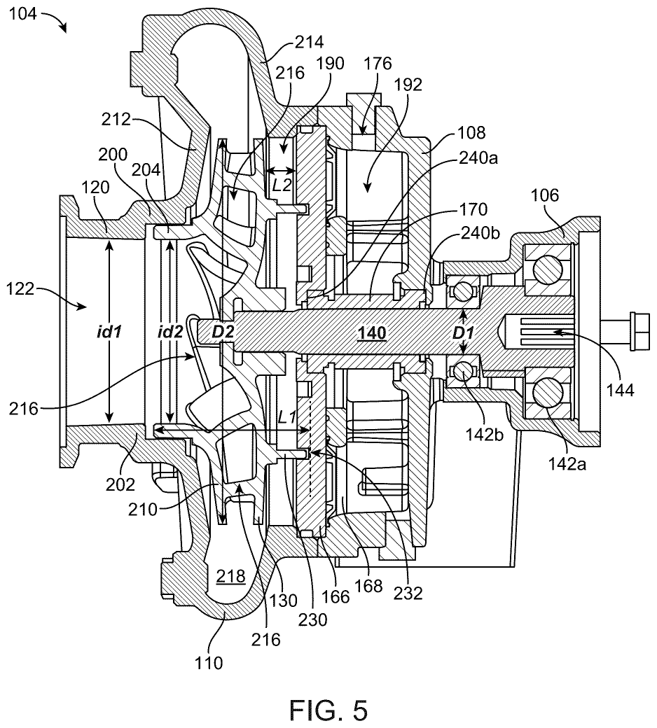

With reference to FIG. 5, the chamber plate 166 is positioned between the volute 110 and the drive-side housing 108. The impeller 130 is disposed within a flow cavity 190 defined by the volute 110 and the chamber plate 166. The diaphragm 168 and the positive drive seal 170 are disposed within a wet seal chamber 192 defined by the chamber plate 166 and the drive-side housing 108. The wet seal chamber 192 may be filled with lubricant via the openings 176. One end of the drive shaft 140 extends into the motor mounting adapter 106 and an opposite end of the drive shaft 140 extends through the drive-side housing 108 and the chamber plate 166 to engage and drive the impeller 130. The impeller 130 can be formed of a metal such as stainless steel. Forming the impeller 130 from stainless steel may provide a longer lifespan for the pump system 100 due to the resistance of stainless steel to abrasion and/or chemicals. Furthermore, using metal, the impeller 130 can be formed using a casting technique in contrast to plastic impellers which are mechanically joined, welded, or epoxied. The cast metal impeller 130 may allow the pump system 100 to have a longer life even with exposure to chemicals and abrasives, as well as increase the impact resistance of the pump system 100 to particulates.

Further, a neck portion 200 of the volute 110 defines an internal shoulder 202 with the inlet port 120. A suction collar 204 of the impeller 130 is disposed within and slidably and rotatably engages the neck portion 200. Thus, the suction collar 204 extends into the neck portion 200. In some instances, a first inner diameter id1 of the inlet port 120 and a second inner diameter id2 of the suction collar 204 are substantially equal. In some instances, the first inner diameter id1 of the volute 110 is about 7.62 centimeters and the second inner diameter id2 of the impeller 130 is about 7.62 centimeters.

An outflow portion 210 of the impeller 130 is substantially centered between a front wall 212 and a rear wall 214 of the volute 110. Thus, a plurality of radial outflow channels 216 defined in the impeller 130 is symmetric and/or axially aligned with a circumferential outflow passage 218, which is defined by the front wall 212 and the rear wall 214 and is in fluid communication with the flow cavity 190. Further, the longest distance between a front surface of the impeller 130 and the front wall 212 of the volute 110 is about one third to about one fourth of the shortest distance between a back surface of the outflow portion 210 and the chamber plate 166. In some instances, a first outer diameter D1 of the drive shaft 140 is between about 5 percent and about 15 percent (e.g., about one tenth) of a second outer diameter D2 of the impeller 130 in length. More specifically, in some instances, the second outer diameter D2 of the impeller 130 is about 15.88 centimeters, the first outer diameter is D1 of the drive shaft 140 is about 1.91 centimeters, a first length L1 of the impeller 130 is about 6.35 centimeters, and/or a distance L2 from the impeller 130 to the chamber plate 166 is about 1.32 centimeters.

Also, a balancing ring 230 is defined on the impeller 130 about the rotational axis X and extends axially rearwardly from the outflow portion 210. The balancing ring 230 extends into a balancing groove 232 defined in the chamber plate 166 so as to rotate within the balancing groove 232 during operation to keep the impeller 130 balanced. Accordingly, the balancing ring 230 is aligned concentrically with the rotational axis X.

The positive drive seal 170 is rotationally and axially fixed to and thus rotates with the drive shaft 140. A first end face 240a and a second end face 240b of the positive drive seal 170 abut and rotate against the chamber plate 166 and the drive-side housing 108 to keep lubricant from leaking out of the wet seal chamber 192. In some forms, springs (not shown) are compressed radially between the drive shaft 140 and the positive drive seal 170 to radially center the positive drive seal 170 relative to the drive shaft 140 such that the drive shaft 140 and the positive drive seal 170 remain substantially concentric during operation.

The positive drive seal 170 is fixed to the drive shaft 140 and therefore self-centering, which can allow for even contact between the first end face 240a and the second end face 240b of the positive drive seal 170 and the chamber plate 166 and the drive-side housing 108. The even contact between the first end face 240a and the second end face 240b of the positive drive seal 170 and the chamber plate 166 and the drive-side housing 108 may extend the life of the pump system 100 due to the reduced wear afforded by the improved alignment. Additionally, the drive shaft 140 is further rotatably supported in and by the motor mounting adapter 106 via a second sealed bearing 142b.

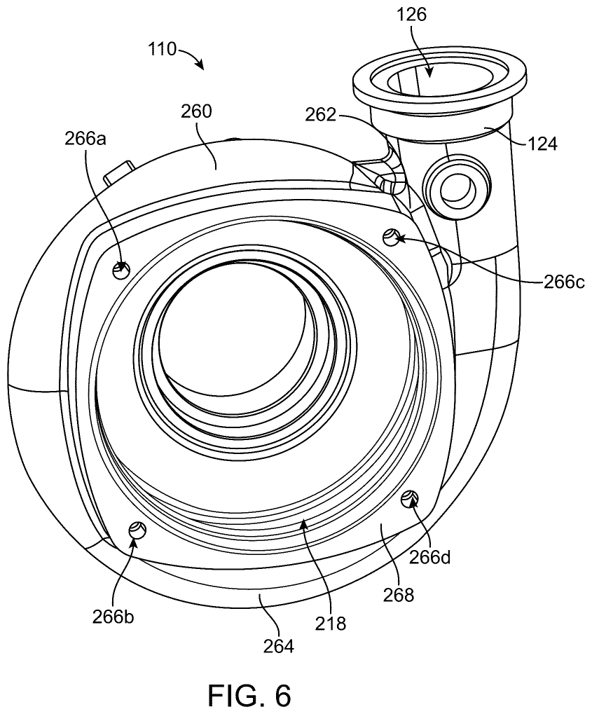

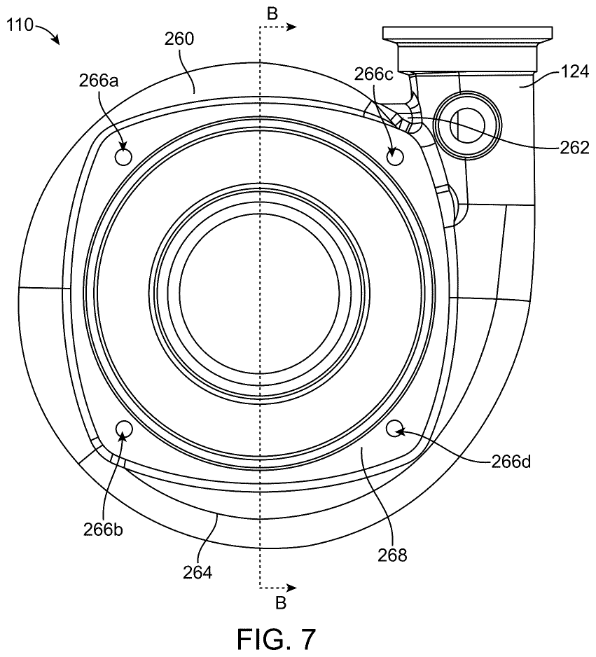

With reference to FIGS. 6-8, along a first portion 260 of the volute 110, the circumferential outflow passage 218 is at least partially fluidly isolated from the outlet 126 by a separating wall 262. Along a second portion 264 of the volute 110, the circumferential outflow passage 218 is in fluid communication with and feeds fluid into the outlet 126. Additionally, as shown in FIGS. 6 and 7, the volute 110 defines a plurality of mounting holes 266a-266d in a mounting face 268.

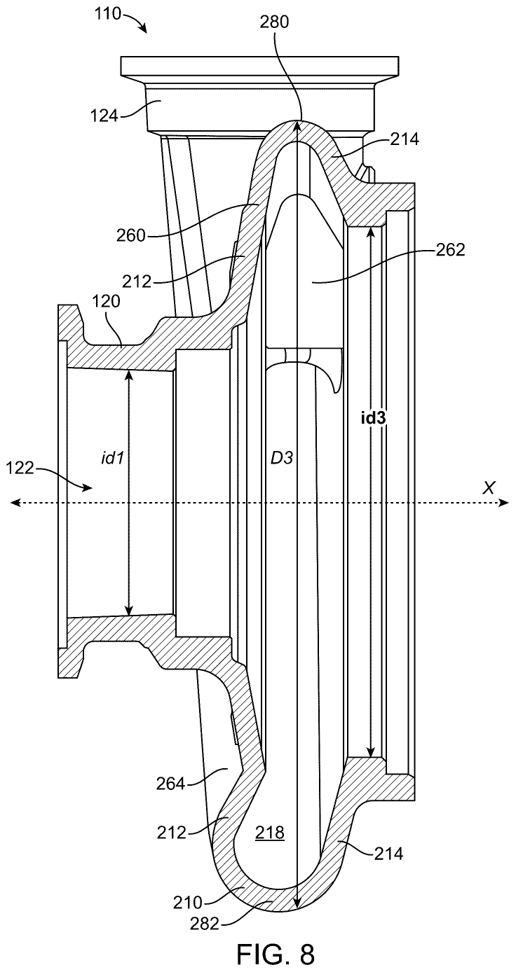

With reference to FIG. 8, along the first portion 260, the front wall 212 and the rear wall 214 are substantially straight and meet at an apex 280. Thus, along the first portion 260, the circumferential outflow passage 218 is substantially V-shaped in cross-section, with the tip of the V being rounded. In some forms, the cross-section of the first portion 260 is parabolic or triangular. Similarly, along the second portion 264, the front wall 212 and rear wall 214 are curved and meet to form an arc 282. As shown, along the second portion 264, the circumferential outflow passage 218 is at least partially C-shaped in cross-section. In some forms, the cross-section of the second portion 264 is at least partially oval (e.g., obround, circular, elliptical, etc.) The front wall 212 and the rear wall 214 smoothly and curvilinearly transition to form the V-shaped cross-section of the first portion 260 and the C-shaped cross-section of the second portion 264. Additionally, relative to the rotational axis X, the apex 280 is radially opposite and thus radially aligned with the arc 282.

Further, in some instances, the first inner diameter id1 is between about 30 percent and about 40 percent (e.g., about one third) of a third outer diameter D3 of the volute 110 in length. In some instances, a third inner diameter id3 partially defining the flow cavity 190 (see FIG. 5) is between about 45 and about 55 percent (e.g., about one half) of the first inner diameter id1 in length. Thus, in some instances, the third inner diameter id3 is between about 60 and about 70 percent (e.g., about two thirds) of the third outer diameter D3 in length. More specifically, in some instances, the third outer diameter D3 of the volute is about 23.62 centimeters.

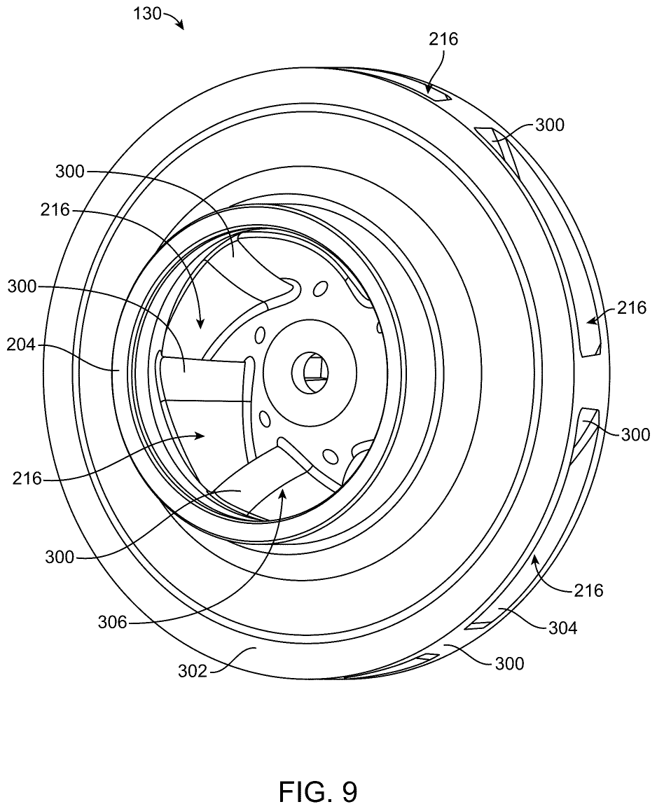

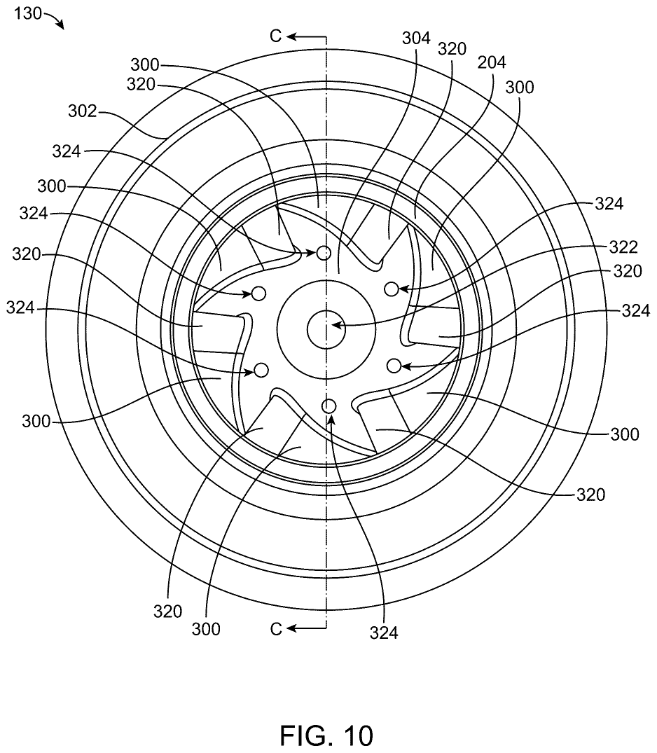

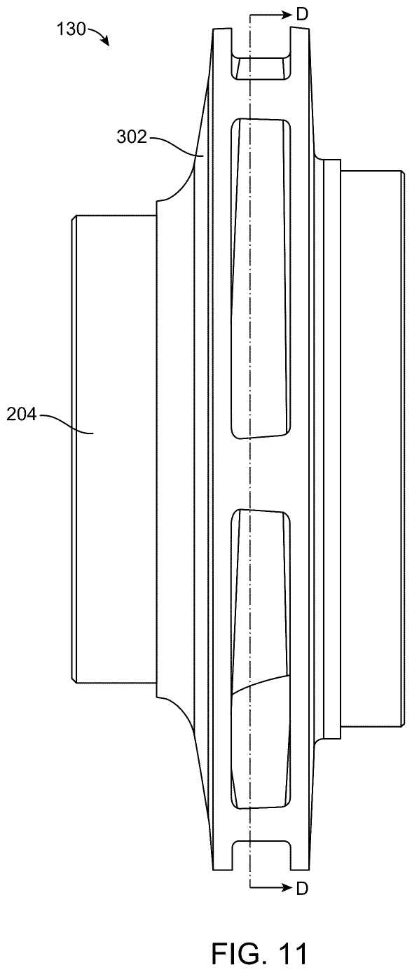

With reference to FIG. 9-12, the impeller 130 includes a plurality of vanes 300 extending axially between and connecting a front wall 302 and a rear wall 304 to define the plurality of radial outflow channels 216. Further, the suction collar 204 extends axially away from the front wall 302. The suction collar 204 defines a suction inlet 306, which is in fluid communication with the plurality of radial outflow channels 216. In some instances, the impeller 130 is formed of stainless steel. In some instances, the plurality of vanes 300 includes no more than six vanes. With reference to FIG. 10, each of the vanes 300 has a leading edge 320 that extends radially outwardly and axially into the suction collar 204. The rear wall 304 defines a drive passage 322 and a plurality of apertures 324. As shown in FIG. 11, the front wall 302 is curved and/or bell-shaped.

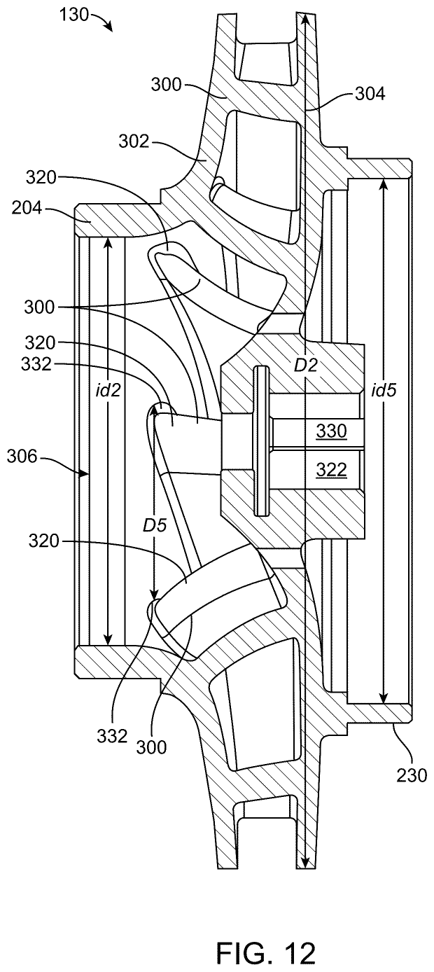

With reference to FIG. 12, each leading edge 320 extends axially into and connects to the suction collar 204. The second inner diameter id2 of the suction collar 204 is between about 45 percent and about 55 percent (e.g., about one half) of the second outer diameter D2 of the impeller 130 in length. A fifth inner diameter id5 of the balancing ring 230 is between about 55 percent and 65 percent (e.g., about three fifths) of the second outer diameter D2 of the impeller 130 in length. Thus, the second inner diameter id2 is between about 75 percent and about 85 percent (e.g., four fifths) of the fifth inner diameter id5 in length. Additionally, in some instances, the drive passage 322 includes a keyway 330. In some embodiments, each of the leading edges 320 forms an apex 332 at the junction between the respective leading edge 320 and the suction collar 204. The apexes 332 are the point of each vane 300 that extends the farthest into the suction collar 204. Further, a distance D5 defined between adjacent apexes 332 can have a length that is about three eighths to about five eighths, or about one half, of the second inner diameter id2. More specifically, in some instances, the fifth inner diameter id5 of the balancing ring is about 9.78 centimeters.

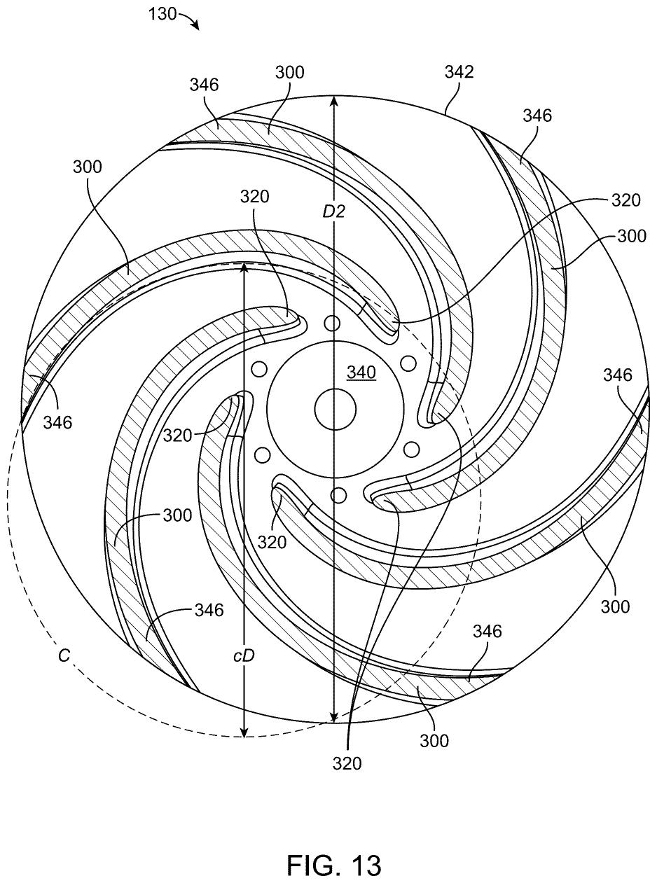

With reference to FIG. 13, the vanes 300 are curved, and extend radially from a central region 340. Further, each of the vanes 300 increases in thickness as they extend from the central region 340 to an outer edge 342 of the impeller 130. Thus, the leading edges 320 are thinner than trailing ends 346 of the vanes 300, respectively. In some instances, an inner curvature circle C partially defines an inner concave curvature of each of the vanes 300. Further, in some instances, a curvature diameter cD of the curvature circle C is between about 65 and about 75 percent (e.g., about seven tenths) of the second outer diameter D2 of the impeller 130 in length.

FIGS. 14-16 illustrate the positive drive seal 170 in further detail. For example, the positive drive seal 170 includes a plurality of set screws 360 that are threadably engaged into set screw holes 361 within a cylindrical body 362 to fix the positive drive seal 170 to the drive shaft 140 (see FIG. 5). A first cup seal 364a is circumferentially disposed about a first end 366a proximate the first end face 240a. A second cup seal 364b is circumferentially disposed about a second end 366b proximate the second end face 240b. The set screw holes 361 are arranged about the circumference of the cylindrical body 362 such that the set screws 360 are radially symmetrical about a longitudinal axis of the cylindrical body 362 when the set screws 360 are installed.

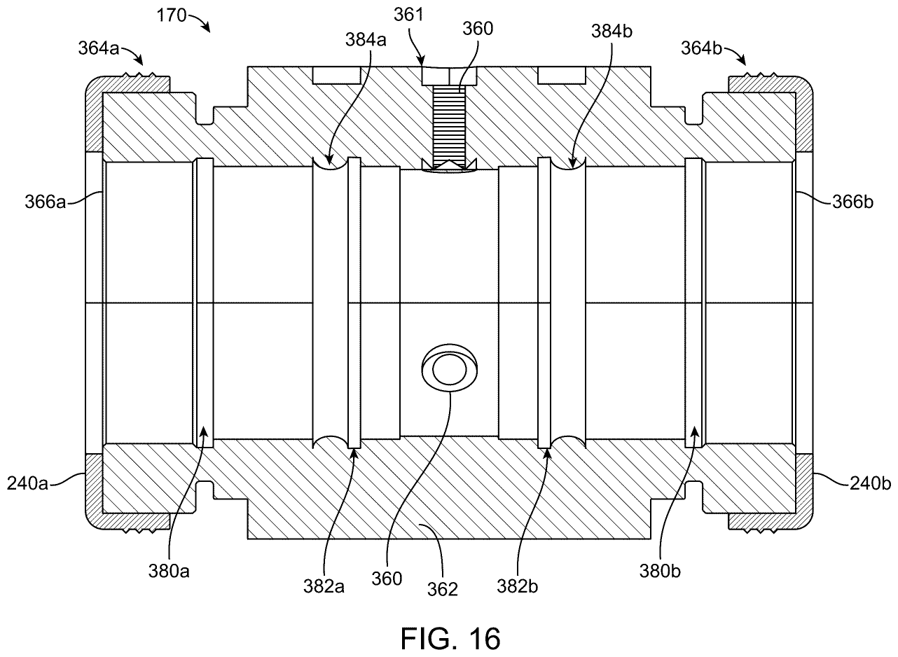

With reference to FIG. 16, the cylindrical body 362 defines a first internal spring groove 380a, a second internal spring groove 380b, a first internal seal groove 382a, and a second internal seal groove 382b. The first internal spring groove 380a is positioned between the first internal seal groove 382a and the first end face 240a. The second internal spring groove 380b is positioned between the second internal seal groove 382b and the second end face 240b. The first and second internal spring grooves 380a, 380b carry springs (not shown) that are evenly spaced about the circumference of the first and second internal spring grooves 380a, 380b and urge the cylindrical body 362 radially away from the drive shaft 140 (shown in FIG. 5), thus radially centering the cylindrical body 362 relative to the drive shaft 140. Further, inner O-ring seals 384a, 384b can be fitted into the first and second internal seal grooves 382a, 382b. The set screws 360 engage and are radially tightened against the drive shaft 140 to fix the cylindrical body 362 relative to the drive shaft 140 axially and rotationally. In some forms, the seals 364A, 364B, 384a, 384b comprise one or more polymers, such as plastic, rubber, or other elastomers. Indeed, fixing the positive drive seal 170 to the drive shaft 140 can help reduce wear on the inner O-ring seals 384a, 384b caused by rotational slipping of the positive drive seal 170 about the drive shaft 140. The inner O-ring seals 384a, 384b can allow for axial movement and prevent leakage better than other techniques such as a bellows style seal, which may allow for leakage if it is not centered and/or shifts axially.

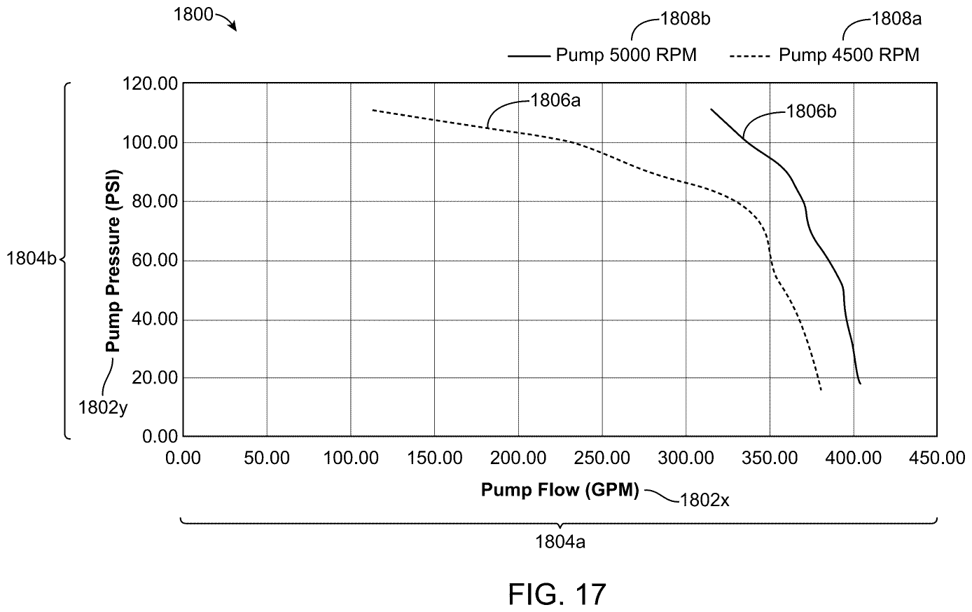

With reference to FIG. 17, a performance graph 1800 has a first axis 1802x of pump flow rates 1804a and second axis 1802y of pump pressures 1804b. The performance graph 1800 further illustrates a first performance curve 1806a and a second performance curve 1806b of the pump 104 (shown in FIG. 2). The first performance curve 1806a illustrates pump flow rates 1804a and pump pressures 1804b when the pump 104 is run at a first rotational speed 1808a. Similarly, the second performance curve 1806b illustrates pump flow rates 1804a and pump pressures 1804b when the pump 104 is run at a second rotational speed 1808b. In some forms, at a pump speed of 5000 revolutions per minute, the pump can have a discharge range of 0 to 400 gallons per minute and a pressure range of 30 to 140 pounds per square inch.

In contrast to previous pump system designs, the pump system 100 provides improved performance in a variety of applications and in a smaller footprint and lighter build while also potentially providing a longer lifespan. In particular, the impeller 130 may be formed of cast stainless steel, which can provide improved protection against a variety of fluids as well as increase protection against particulates compared to other materials such as plastic. Furthermore, the positive drive seal 170 can provide a potentially longer lasting and/or more reliable pump system 100 due to the improved alignment and even contact of the positive drive seal 170 with other components of the pump system 100. Still further, the pump system 100 is modularly adaptable to receive a variety of motor types, such as hydraulic and electric motors. As another advantage over other pump systems, the pump system 100 can weigh less than fifty pounds (e.g., about forty-five pounds). In contrast, other pumps with similar performance may weigh closer to one hundred pounds (e.g., about ninety pounds). Keeping the weight of the pump system 100 below fifty pounds may allow for easier manufacturing and/or installation, as the pump system 100 may be able to be handled (e.g., lifted) by a single human. In all, the pump system 100 provides the performance of pumps nearly twice as heavy and having larger footprints, while also potentially providing longer life and/or reliability in a variety of applications.

In other embodiments, other configurations are possible. For example, those of skill in the art will recognize, according to the principles and concepts disclosed herein, that various combinations, sub-combinations, and substitutions of the components discussed above can provide improved pump systems.

What is claimed is:

1. A pump comprising:
a volute having an inlet port;
an impeller at least partially disposed within the volute, the impeller having a suction collar extending axially into the inlet port;
a drive-side housing mounted to the volute;
a chamber plate positioned between the volute and the drive-side housing, the chamber plate and the drive-side housing defining a wet seal chamber;
a drive shaft secured to the impeller and extending through the wet seal chamber; and
a positive drive seal disposed in the wet seal chamber, the positive drive seal being non-rotatably secured about the drive shaft and rotatably engaged with the chamber plate, the positive drive seal forming a seal with the chamber plate.

2. The pump of claim 1, wherein the positive drive seal is rotatably engaged and forms a seal with the drive-side housing.

3. The pump of claim 1, wherein the impeller is axially centered between a front wall and a rear wall of the volute.

4. The pump of claim 1, wherein
the volute defines a circumferential outflow passage,
the circumferential outflow passage is substantially V-shaped in cross-section along a first portion of the volute, and
the circumferential outflow passage is C-shaped in cross-section along a second portion of the volute.

5. The pump of claim 4, wherein radial outflow channels defined in the impeller are axially aligned with the circumferential outflow passage.

6. The pump of claim 4, wherein an apex along the first portion of the volute is radially opposite an arc along the second portion of the volute.

7. The pump of claim 1, wherein a first inner diameter of the inlet port is approximately equal to a second inner diameter of the suction collar.

8. The pump of claim 1, wherein a diaphragm disposed in the wet seal chamber regulates fluid pressure within the volute.

9. The pump of claim 1, wherein an inner diameter of the inlet port is between 30 percent and 40 percent of an outer diameter of the volute in length.

10. A pump comprising:
a volute having an internal shoulder defined by an inlet port and a neck portion; and
an impeller rotatable relative to the volute, the impeller having
a suction collar disposed in the neck portion, the suction collar and the inlet port being substantially equal in inner diameter, and
a vane having a leading edge extending axially into the suction collar.

11. The pump of claim 10, wherein
the vane has a leading end and a trailing end, and
the leading end has a first thickness dimension that is smaller than a second thickness dimension of the trailing end.

12. The pump of claim 10, wherein the leading edge connects to the suction collar.

13. The pump of claim 10, wherein
the vane is one of a plurality of vanes, and
the plurality of vanes includes no more than six vanes.

14. The pump of claim 13, wherein a distance defined between adjacent apexes of the vanes ranges from about three eighths to about five eighths of an inner diameter of the suction collar.

15. The pump of claim 10, wherein the impeller has a balancing ring larger in inner diameter than the suction collar.

16. The pump of claim 10, wherein an inner diameter of the suction collar is between 45 percent and 55 percent of an outer diameter of the impeller in length.

17. The pump of claim 10, wherein an inner curvature diameter of the vane is between 65 percent and 75 percent of an outer diameter of the impeller in length.

18. The pump of claim 10, wherein the pump has an overall build envelope that fits within a space of 20.1 centimeters (cm) by 26.1 cm by 25.4 cm.

19. A pump system comprising:
a pump having
a motor mounting adapter,
a drive shaft extending into the motor mounting adapter, and
a positive drive seal non-rotatably secured about the drive shaft to fluidly isolate a wet seal chamber from a volute; and
a motor removably supported by the motor mounting adapter, the motor having a motor shaft removably coupled to the drive shaft, wherein
the pump and the motor have a combined weight of less than 50 pounds.

20. The pump system of claim 19, wherein an end of the motor shaft is inserted into a motor shaft cavity defined in the drive shaft.

21. The pump system of claim 19, wherein the motor is one of electrically powered or hydraulically powered.
